(19) United States
(12) Patent Application Publication
(10) Pub. No.: US 2006/0278727 A1
(43) Pub. Date: Dec. 14, 2006

(54) Pressure regulating nozzle assembly

(75) Inventor: Carl L.C. Kah JR., North Palm Beach, FL (US)

Correspondence Address: OSTROLENK FABER GERB & SOFFEN, 1180 AVENUE OF THE AMERICAS, NEW YORK, NY, 100368403, US

(73) Assignee: K-RAIN Manufacturing Corp.

(21) Appl. No.: 11/438,796

(22) Filed: May 22, 2006

Related U.S. Application Data
(60) Provisional application No. 60/683,548, filed on May 20, 2005.

(51) Int. Cl. A01G 27/00

(52) U.S. Cl. 239/67; 239/68; 239/69

(57) ABSTRACT

An irrigation sprinkler nozzle assembly including a pressure regulator having a low friction seal for a riser assembly in which the regulator is installed. The pressure regulator includes a movable portion, a fixed portion located upstream of the movable portion, and connectable to a water inlet, and a biasing member such as a spring which applies a force to the movable portion according to a pressure differential between the water inlet pressure and a reference pressure. The fixed and movable portions move relative to each other according to the force provided by the biasing member to provide a variable flow restriction which maintains the desired pressure. The low friction seal is a diaphragm connected at one end to the movable member and anchorable at another end in the nozzle head.

### CROSS-REFERENCE TO RELATED APPLICATIONS

This application is based on and claims priority to U.S. Provisional Application 60/683,548, filed May 20, 2005, the entire disclosure of which is incorporated herein by reference.

### BACKGROUND OF THE INVENTION

Several of the major manufacturers of irrigation equipment, have spray heads with a pressure regulating valve incorporated into the sprinkler riser assembly. One such device is shown in U.S. Pat. No. 4,913,352. These devices all have “O” ring regulating piston seals which engage the inner surface of the riser tube to prevent leakage. Especially after they have been exposed to dirt and minerals in the water during use the friction between the seal and the tube can become quite high. To assure proper retraction of the riser, large powerful springs, e.g., exerting a force of 5-6 pounds, are required. To accommodate the large spring requires a large sprinkler head. As a consequence, available pressure regulating sprinkler heads can not be used as replacement units for upgrading existing sprinkler heads, in which the riser return spring, because of the low moving friction and smaller size, can be 1½-2 lbs. A need thus exists for a more compact pressure regulating nozzle assembly.

### SUMMARY OF THE INVENTION

The present invention seeks to satisfy the need for a compact simple pressure regulating valve by using a stepped diaphragm valve as disclosed in U.S. patent application Ser. No. 10/118,490, the disclosure of which is incorporated herein by reference as if fully disclosed. The result is a reliable configuration that is small enough to be incorporated into the spray nozzle and filter assembly of a spray type sprinkler nozzle assembly to provide uniform performance over a wide-range of pressure sprinkler inlet pressures.

The new construction would, for example, allow installation of these nozzles into existing spray heads along highways where pressures are sometimes high causing much wasted water over-spray onto the roadways and the danger of accidents. My U.S. Pat. No. 6,834,816 B2 shows an adjustable spray nozzle with an attached filter as a non-limiting example of a construction with which the present invention could be used. The disclosure of the '816 patent is incorporated herein by reference as if fully disclosed.

### BRIEF DESCRIPTION OF THE DRAWING(S)

FIG. 1 is a cross-sectional view of an adjustable arc spray nozzle with an attached filter which houses a pressure regulating valve; pressure regulating valve port shown in open position

FIG. 2 is the same as FIG. 1 except with the pressure regulating valve shown in an exemplary throttling operating position to provide, i.e. 30 p.s.i. to the spray nozzle of the sprinkler.

### DETAILED DESCRIPTION OF PREFERRED EMBODIMENTS OF THE INVENTION

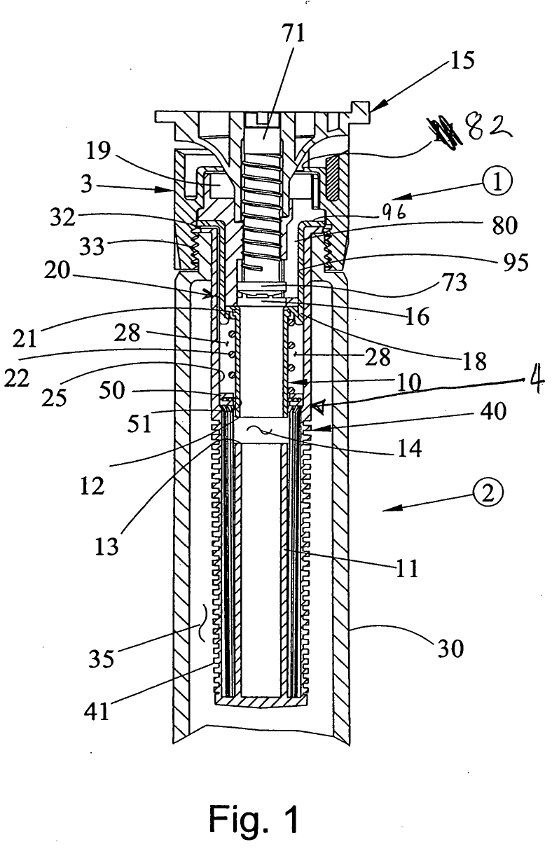

FIG. 1 shows a cross section of an adjustable arc spray nozzle assembly generally designated at 1. This is comprised of a riser 2, a filter assembly 5, a nozzle head 3, and a pressure regulator assembly 4 incorporated into filter assembly 5. These elements are housed in an outer casing (not shown). The riser 2 may be part of an existing installation, with the other identified elements constituting a unit adapted for replacement installation into the existing riser.

The assembly shown is conventional and its construction and operation are well known to those skilled in the art.

It is to be understood that the pressure regulating mechanism is shown in this assembly for exemplary and illustrative purposes, but is adaptable within the scope of the invention for use in other pop-up sprinkler assemblies and other nozzle head constructions as well.

Pressure regulator 4 functions to sense outside pressure and throttles the flow rate to the nozzle to provide a relatively constant pressure for exiting water stream. The nozzle of course can be a fixed spray as well as the adjustable arc spray shown.

Regulator 4 is comprised of an axially movable hollow flow throttling member 10 which acts in conjunction with a hollow tube member 11 extending up from the bottom of the filter to provide a flow restriction between the bottom 12 of member 10 and the top end 13 of member 11.

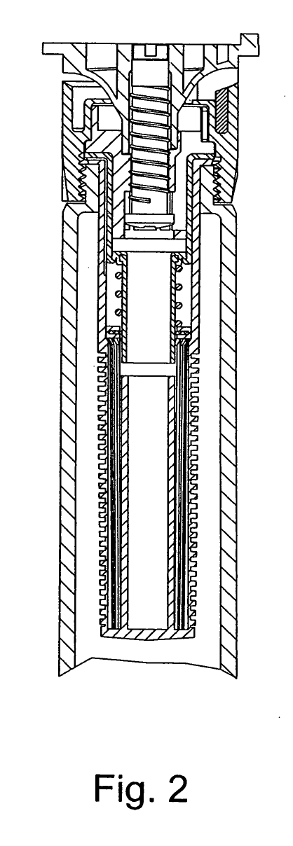

Pressure control flow throttling member 10 is shown in FIG. 2 in a partially throttled position. The flow area around the circumferential bottom edge 12 and the circumferential top edge 13 determine the pressure drop for the flow up the hollow center of member 10 and into cavity 16 located above flow throttling member 10, and which provides communication through circumferentially spaced axial slots 80 forming an outlet flow path to a nozzle outlet 82.

The flow throttling member 10 includes a circumferential rib having a radially extending edge 21.

A stepped diaphragm seal 20 of the type described in my above-identified '490 application seals the upper end of spring cavity 28. Seal 20 is comprised of a first end 18 co-molded, or otherwise formed as an unitary structure with rib edge 21, an axial extending portion 95, and a radially extending upper end 96 suitably anchored in nozzle head 3.

The illustrated diaphragm seal 20 is particularly advantageous in that is impose very low friction on the movement of regulator tube 10, yet provides a reliable seal between outside filter housing wall 25 and the top of member 10. This is because the seal flexes as tube 10 moves upward and carries end 18 upward, shortening portion 95, and forming a generally u-shaped bend at its lower end.

A spring 22 located in a cavity 28 acts against the underside of edge 21 to try to push the flow throttling member 10 up and open flow area 16. Pressure on the upper surface of top edge 21 and the diaphragm seal 20 pushes the throttling member downward against the upward force of spring 22.

The pressure in spring cavity 28 is maintained at atmosphere pressure by a vent slot in the wall 25 of the filter basket which extends to the top of the filter basket where it exits radially outward at 32 to vent to atmospheric pressure through the threads 33. Thus, a true pressure reference is provided internally so that a relatively correct referenced differential pressure between the inside of the spray nozzle and the outside atmospheric discharge area is established for a uniform flow and sprinkler performance over a wide range of possible sprinkler inlet pressures, 30 to 90 p.s.i.

Water at inlet pressure is supplied through a flow path comprising the interior 35 of sprinkler riser tube 2, filter slots 41 of filter basket 40, pressure regulating flow area 14, and the interior of member 10 to area 16 of an adjustable spray nozzle 15 upstream throttling valve area. From here, the water flows past the upstream throttling valve screw head 73 and through slots 80 to the spray nozzle adjustable discharge orifice 82.

The lower end of the atmospheric reference and spring cavity 28 has shaft seal member 50 which has thin lip wiper seal 51 for the hollow shaft of flow throttling member 10 to allow it to move with a minimum of friction.

The spring 22 can be pre-compressed to hold the flow control member up and fully open and not move downward to throttle until the pressure in the nozzle housing cavity 16 has reached a desired level such as 30 p.s.i. The spring should have a low spring rate with sufficient active coils so that the pressure or force required to continue to compress the spring and throttle the flow further is not excessively higher as inlet pressure at 40 and inside the filter at the throttling valve inlet area 14.

Although the present invention has been described in relation to particular embodiments thereof, many other variations and modifications and other uses will become apparent to those skilled in the art. It is intended, therefore, that the present invention be limited not by the specific disclosure herein, but only by the appended claims.

What is claimed is:

1. Nozzle assembly including pressure regulator adapted to be installed in an existing sprinkler system to improve spray performance and reduce water usage and waste.

2. An irrigation sprinkler nozzle assembly including:
a nozzle head including a nozzle spray outlet, and an outlet flow path coupled to the nozzle spray outlet; and
a pressure regulator located upstream of the outlet flow path,
the pressure regulator comprising:
a movable portion;
a fixed portion located upstream of the movable portion, and connectable to a water inlet;
a biasing member for applying a variable force to the movable portion according to a pressure differential between the water inlet pressure and a reference pressure;
the fixed and movable portions being movable relative to each other according to the force provided by the biasing member to provide a variable flow restriction,
wherein the nozzle is connectable to a riser with the pressure regulator in the riser; and
a low friction seal operable to prevent leakage from the riser as the movable portion moves relative to the fixed portion.

3. A sprinkler nozzle assembly according to claim 2, wherein the low friction seal is comprised of a diaphragm seal connected at one end to the movable member and anchorable at another end in the nozzle head.

4. A sprinkler nozzle assembly according to claim 2, wherein the biasing member is located in a cavity which provides a pressure reference, and is preset to provide no flow restriction when the inlet pressure is below a desired level.

5. A sprinkler nozzle assembly according to claim 4, where the reference pressure is atmospheric pressure.

6. A sprinkler nozzle assembly according to claim 2, wherein the biasing member is so positioned that it is anchored relative to the fixed portion, and applies a force to the movable portion in a direction to relieve the flow restriction.

7. A sprinkler nozzle assembly according to claim 2, wherein the biasing member is a spring.
